(19) United States
(12) Patent Application Publication
(10) Pub. No.: US 2020/0143591 A1
(43) Pub. Date: May 7, 2020

(54) SYSTEM AND METHOD FOR CREATING INTERACTIVE GPS-INTEGRATED, 3D-MODELLED SPACES

(71) Applicant: DIMENSIONAL ASSET SOLUTIONS, LLC, WEATHERFORD, TX (US)

(72) Inventors: ROSS H. WATKINS, WEATHERFORD, TX (US); STEVEN TANNER CLARK, CANYON, TX (US); ADDISON WAYNE RHUDY, MISSOURI CITY, TX (US); SIERRA BREANN POTTS, WEATHERFORD, TX (US)

(21) Appl. No.: 16/673,732

(22) Filed: Nov. 4, 2019

Related U.S. Application Data
(60) Provisional application No. 62/754,620, filed on Nov. 2, 2018.

(51) Int. Cl. G06T 19/00; G06T 17/05

(52) U.S. Cl. CPC G06T 19/003; G06T 17/05; G06T 2200/24; G06T 2219/004; G06T 2219/024; G06T 2200/04

(57) ABSTRACT

System and method for interfacing with digital 3D representations of real-world locations. Embodiments of the present invention are directed to allowing for remote monitoring and digital traversal of building or facility interiors with real-time GPS integration.

### CITATION TO PRIOR APPLICATIONS

The present application claims priority to U.S. Provisional Application No. 62/754,620, titled “SYSTEM AND METHOD FOR CREATING INTERACTIVE GPS-INTEGRATED, 3D-MODELLED SPACES” and filed on Nov. 2, 2018.

### BACKGROUND AND SUMMARY OF THE INVENTION

The present invention relates generally to the creation and use of digital 3D-modelled locations utilizing specialized, mapped location data and a related software platform to interface with such data.

While prior art approaches for creating digital location models allow for interaction with such models to an extent including simulated walkthroughs of interior spaces, the present invention integrates additional information into mapped location data to provide further practical utility. It is one object of the present invention to allow couple portions or sections of mapped location models, both exterior and interior, with real world positioning information. It is a further object that items captured in the mapped location models may have additional information about such items coupled to the models. Yet another object of the present invention is to further couple location data is that updated in substantially real-time to the mapped location models. Users may then access the mapped location models and any related information via a web-based, or other software, platform.

Through this coupling of data, a dynamic system is created through which users may remotely monitor on a computing device conditions of any real world site that has been mapped and modelled as contemplated by the present invention. Specifically, and improving over the capabilities of the prior art, the integration of real-time location data (by coupling with GPS devices) allows for the remote monitoring and guidance of emergency, rescue, or other personnel as they traverse interior physical spaces captured by mapped location models.

### BRIEF DESCRIPTION OF THE DRAWINGS

FIG. 1 depicts one implementation of a UI element representing a Panel Bar, Insert Form, and Grid as used throughout the platform of one embodiment of the present invention.

FIG. 2 depicts one implementation of a UI element representing a Customer page from one embodiment of the present invention with the “Add Customer” panel toggled open.

FIG. 3 depicts one implementation of a UI element representing a Location page from one embodiment of the present invention with the “Add Location” panel toggled open.

FIG. 4 depicts one implementation of a UI element representing an LIM page from one embodiment of the present invention with the “Add LIM” panel toggled open.

FIG. 5 depicts one implementation of a UI element representing a Maps Setting page from one embodiment of the present invention.

FIG. 6 depicts one implementation of a UI element representing a Register User form from one embodiment of the present invention.

FIG. 7 depicts one implementation of a UI element representing a User Lists page from one embodiment of the present invention.

FIG. 8 depicts one implementation of a UI element representing an Assign Users page from one embodiment of the present invention.

FIG. 9 depicts one implementation of a UI element representing a Locations Lists grid from one embodiment of the present invention.

FIG. 10 depicts one implementation of a UI element representing a Location Image Map page from one embodiment of the present invention displaying a Location Image Map to one position of a selected Location.

FIG. 11 is a site map according to one embodiment of the mapped location interface platform of the present invention.

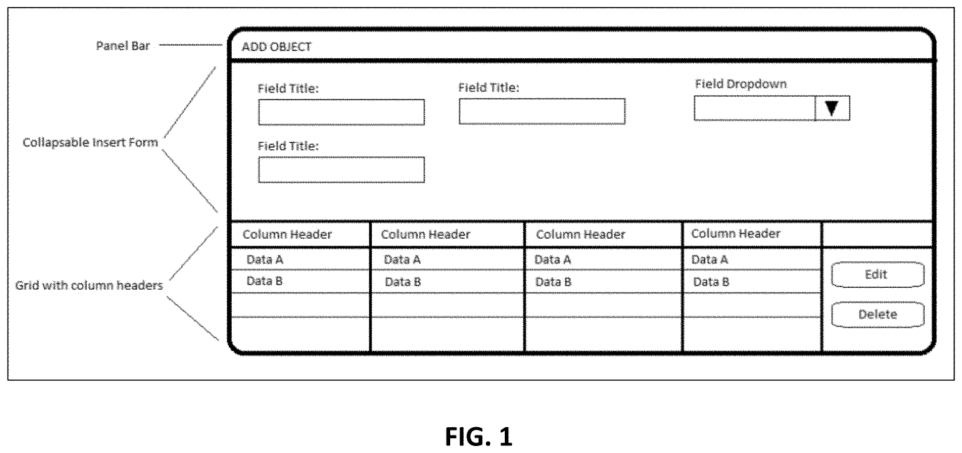

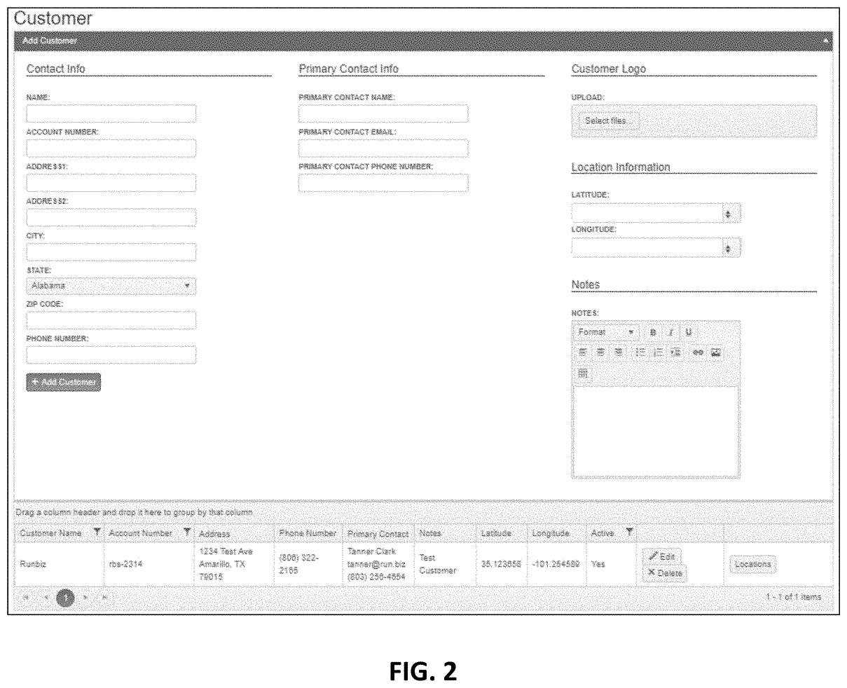

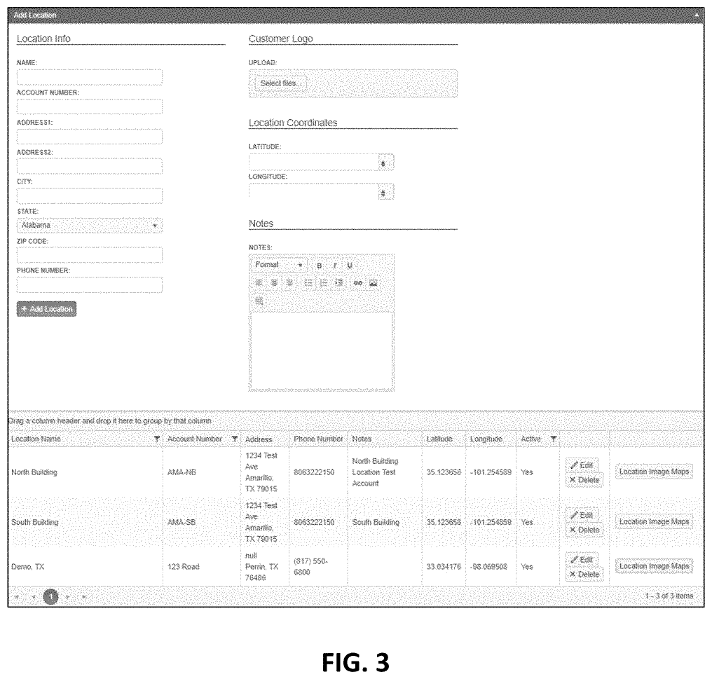

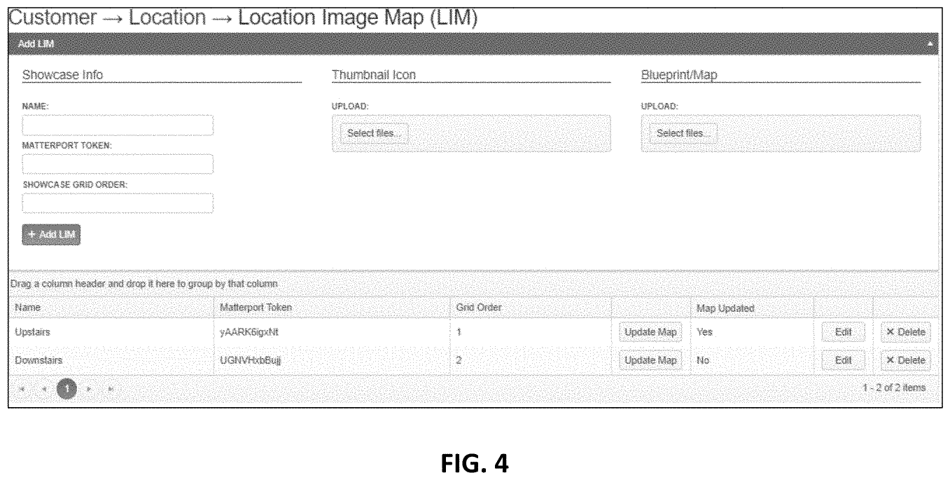

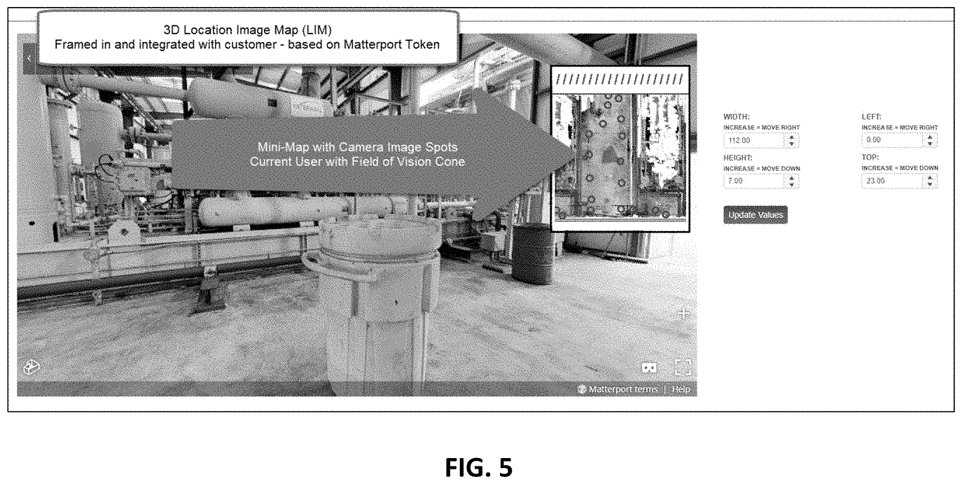

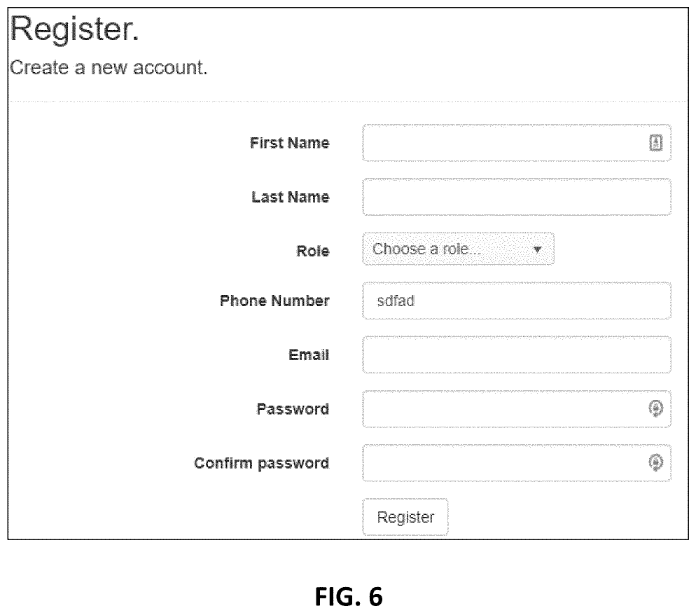

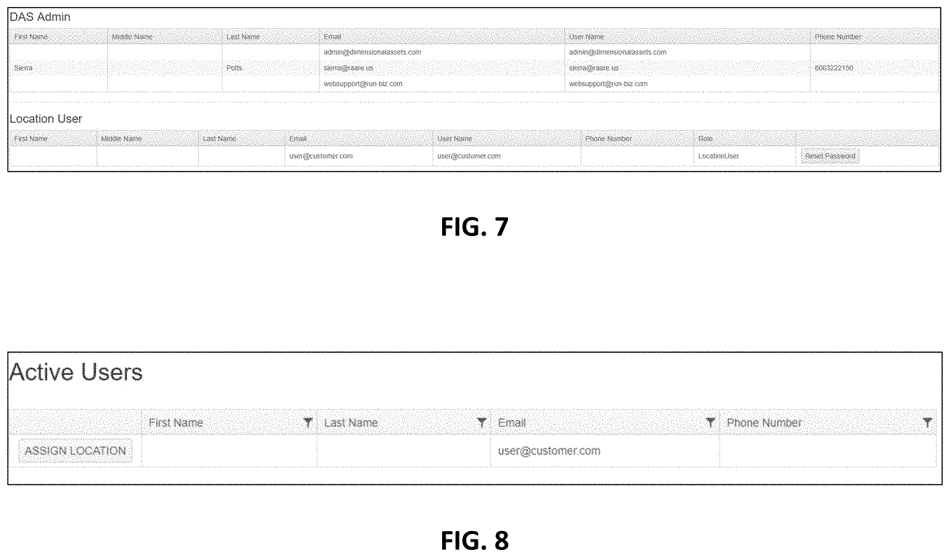

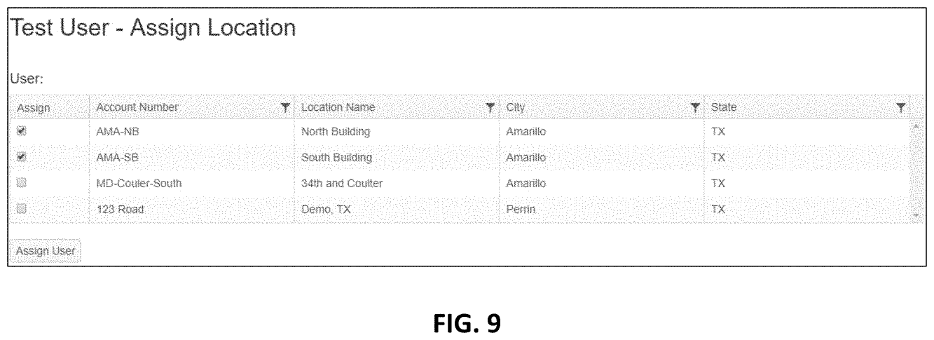

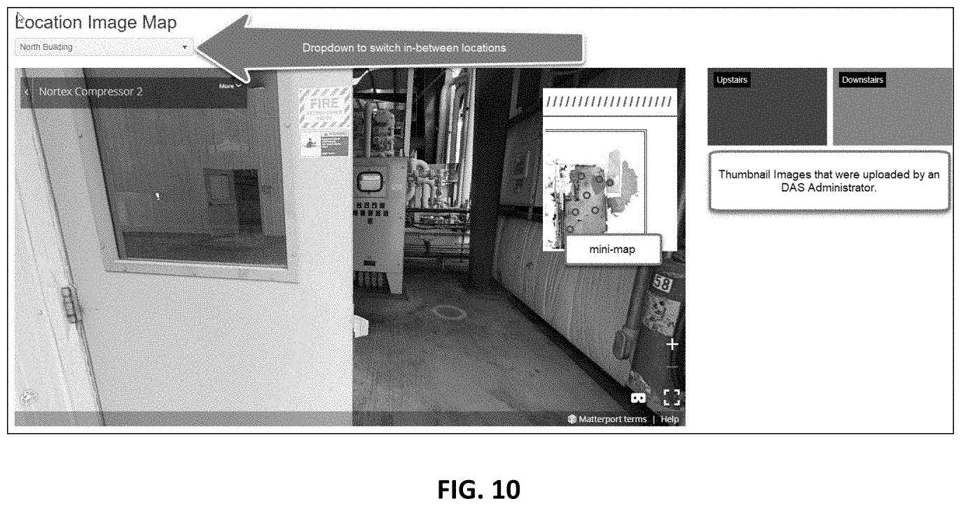

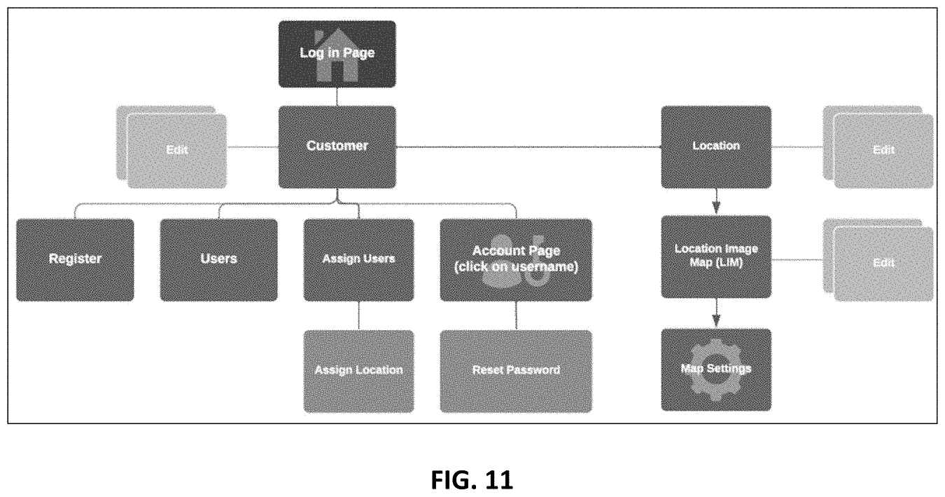

### DETAILED DESCRIPTION OF THE INVENTION

This description, along with the accompanying figures, presents non-limiting examples of embodiments of the present invention. Although specific hardware and software solutions or techniques may be described herein, a person of ordinary skill in the art would recognize that any number of equivalents to such solutions or techniques could be otherwise used to realize various embodiments of the present invention.

Certain embodiments of the present invention comprise a set of mapped location data. This set of mapped location data may itself include at least one digital location model or image, data representing a static geographic position, and secondary model information representing additional details about positions within or items or objects related to a location. These embodiments may further comprise substantially real-time position data used to present the location of a positioning device, which serves as a source of said substantially real-time positioning data, on said digital location model or image. Some embodiments will also comprise a mapped location interface platform configured to allow users to interact with, and in some cases modify, said set of mapped location data.

In other embodiments, the set of mapped location data may comprise a plurality of digital location models or images that, as combined, create a digitally traversable 3D-space representing an area within a location.

One non-limiting embodiment of the present invention, describing properties of said set of mapped location data, and the manner in which elements of such data are coupled with each other or with various other components of the invention, is set forth below from the perspective of implementing the mapped location interface platform.

Mapped Location Interface Platform. The primary function of the platform (or application) is to provide users with a web-based, easy-to-use tool that provides a 3D model or image of their facility and through which users may interface with equipment within said facility. Utilizing cutting-edge imaging techniques, all assets can be readily documented in digital storage and configured for user access.

The application may be built using the ASP.NET MVC framework. This is a framework known in the art that specializes in building web applications using the model-view-controller design pattern. Basic implementation of this embodiment of the present invention can be achieved through the use of three separate projects that follow the MVC pattern—the Web Application, Model, and Database projects. A fourth project corresponding to a Windows Service, however, is additionally contemplated to provide enhanced functionality achieved through its collection of GPS data from integrated GPS devices.

Web Application (View and Controllers) Project. During the creation of the Web Application project, the integrated development environment (“IDE”) will set up several default folders and files. Folders for Views, Controllers, Scripts, Styles, and App Start will be created along with a Web.Config file. Default files for controllers, views, scripts, and styles will be automatically added to the newly created folders. Before continuing, configure the database location, name, and specify the authentication information. These settings are added to the Web.Config file and will be used by ASP.NET Identity and the Database Project.

Implementation of this embodiment also contemplates integration of the ASP.NET Identity system. This system provides the back-bone to the relevant authentication services. When setting up ASP.NET Identity, the option to use “Individual Accounts” should be selected. This option provides that each user will have their own username and password. A password policy should then be established and two separate roles set up. The first of these roles is the Administrator. Users with this role will have permissions to all pages and features. The other role that needs to be created is the Location User. Users with this role will only have access to view their locations and the associated mapped location data that has been assigned to them. The ASP.NET Identity installation will also bring in several new views, controllers, and will, based on the initial configuration, provide the membership entities class. The Identity installation will create the application's database with the necessary tables that Identity needs to manage user accounts and roles. The new database that ASP.NET Identity creates will also be the primary database for the platform.

The MVC web application utilizes shared views that will act as a master page. These shared views will store the Style Sheet Locations, Script File Locations, a header, menu, and footer. When content views are created, a default shared view must be specified so that all pages can have the same header, menu, footer, etc. without having to re-code those on every page.

Views and controllers must also be created to manage Customers, Locations, mapped location data (including 3D Image Mini-Map Settings and a 3D Image Mini-Map), GPS configurations, GPS Devices, Personnel Management, and User Configurations. User Configurations include views that will allow an Administrator to set up new users, assign Location Users access to their specific Locations, reset passwords, and assign GPS devices to Personnel Users.

Each view will need to include:
Customers (Insert form, Grid to reading data, Edit, and delete)
Locations (Insert form, Grid to reading data, Edit, and delete)
3D Image Windows (alternatively referred to as “3D Image Map” Window or “Location Image Map” Window) per Location (Insert form, Grid to reading data, Edit, and delete)
3D Image Mini-Map Settings (see Mini-Map Settings section)
3D Image Mini-Map GPS Configuration (See GPS Tracking Integration section)
GPS Devices (Insert form, Grid to reading data, Edit, and delete)
GPS Device Order Form (see GPS Device Order Form section)
Personnel Management (Insert form, Grid to reading data, Edit, and delete)
User Management for each role (Insert form, Grid to reading data, Edit, and delete)
Assign Location Users (see Assign Device to Personnel User section)
Reset Password Form
Add GPS Devices to Personnel Users (Insert form, Grid to reading data, Edit, and delete)

The Location User Views/Controllers must also be created and will composed of two views:
Location 3D Image Window—Will include the integrated iFrame for the 3D representation of a space provided by the camera manufacturer. Mini-Map will be in top-right corner of the 3D Image Window.
Floor Plan Mode—This will be a top-down view of the facility floor plan. It will display GPS markers for each Personnel User.

Model Project. All of the Models and ViewModel objects are declared in this project. Each Model is a cs file containing the various properties that will be used by that object. A reference in the Web Application Project to the Model Project must be set up so that they can share components. Each Model object will also represent a database table that will be created in the Database Project. After a schema mock-up is created, creation of the actual cs files should begin. Data Annotations assembly should be used to specify required properties, foreign keys, and display names. The classes that need to be created are “Customers”, “Personnel User” (with a foreign key to “Customers”), GPS Device (with a foreign key to “Customers”), “Personnel User GPS Device” (with foreign keys to “Personnel Users” and “GPS Devices”), “Locations” (with a foreign key to “Customers”), “Location 3D Images” (with a foreign key to “Locations”), and then a table to store which “Locations” a “Location User” has been assigned. Once the Model Project is built, you are ready to create the Database Project and add the tables to the database that ASP.NET Identity created during the Web Project setup.

Database Project. Creation of the Database Project contemplates use of the Entity Framework. The Entity Framework is used to manage the communication between the application and database. It serves as a map between the users submitting forms and how the data ends up in the database. An entity context is created in which all the Model objects in the Model Project are specified. When a migration script is executed, the tables in the database that mirror the Model objects are created.

Integrating the Platform with the Mapped Location Data. It is envisioned that a specialized camera designed to capture digital images to generate a 3D-modelled space (such as those developed by Matterport) will be used to provide 3D representations of user specified locations. As understood by persons of ordinary skill in the art, manufacturers of such cameras will provide a software development kit (“SDK”) to facilitate the use of any images or other data produced by their cameras. Interactions with a manufacturer's application programming interface (“API”) are primarily on the client-side using JavaScript. Specific instructions to communicate with a manufacturer's API is readily available in documentation provided by such manufacturers. Furthermore, it is understood that the code necessary to frame in a 3D representation of a space generated by a digital image, or images, after it has been captured by a camera and uploaded to a manufacturer's data hosting service can similarly be found in such documentation. This embodiment provides the platform that links customer accounts to the mapped location data, especially the 3D representations, of their respective facilities (or locations). Through this platform, a customer may be set up and linked to 3D representations of their selected locations which will be grabbed from the database by the location's API token thereby allowing for a page displaying such 3D representations to be dynamically built upon log-in.

Additional Frameworks. This embodiment further contemplates the use of additional user interface (“UI”) helpers and script libraries including:
Kendo UI Suite to enhance the ASP.NET/HTML Input controls;
jQuery to enhance JavaScript functionality;
NewtonSoft.Json to help format the data that is being transmitted between the client and server; and
Angular to help add data management to standard HTML tags and JavaScript.

Database Server. A relational database is used to store the platforms data and documents. A database engine, running on “server level” hardware, should be used to store the data and documents. The tables in the database will mirror the model objects specified in the Web Application Project (for Identity) and the Model Project.

Customer Management Page, Role: Administrator. The platform will include a customer management page is where the primary account for each customer is tracked.

This page includes a “Panel Bar” that will open and collapse upon clicking. When opened it will display the Customer Insert Form. When collapsed it will hide the Customer Insert Form and display the title of “Add Customer”. Under the “Panel Bar” is a grid that lists all customers in a table. It is a paging-enabled table with sortable column headers and data rows. Each row represents a customer. In addition to the customer data in each row there are also three buttons:
“Edit” button: When clicked it will disable the primary features of the customer page with a shaded overlay and then open a pop-up that lists all the customer properties in an editable form.
“Delete” Button: When clicked it will prompt the Administrator user to verify that the customer is to be deleted. If the action is verified, the customer will be marked as deleted in the database. This does not remove the customer from the database at this time but simply flags them as deleted rendering them effectively hidden. If “Cancel” is selected, the action is cancelled, and the normal screen will be displayed.
“Locations” Button: When clicked it displays the customer's location screen.

A sample customer form may include the following fields:
Name—Textbox, Alpha-Numeric, Required, Filterable by Text, Sortable
Account Number—This will be manually assigned to fit our current customer identification scheme. Textbox, Alpha-Numeric, Required, Filterable by Text, Sortable
Address 1—Textbox, Alpha-Numeric, Required, Sortable
Address 2—Textbox, Alpha-Numeric, Optional, Sortable
City—Textbox, Alpha-Numeric, Required, Sortable
State—Dropdown containing all 50 States and Washington D.C., Alpha-Numeric, Required, Sortable
Zip Code—Textbox, Alpha-Numeric, Required, Sortable
Phone Number—Masked Textbox, Numeric, Required, Sortable
Primary Contact Name—This is the full name of our primary contact with the customer. Textbox, Alpha-Numeric, Optional, Sortable
Primary Content Email Address—Textbox, Alpha-Numeric, Optional, Sortable
Primary Contact Phone Number—Textbox, Alpha-Numeric, Optional, Sortable
Logo—This will be uploaded to our server and used in reports. File Upload UI Component, Optional
Latitude—Numeric Textbox, Numbers, Optional
Longitude—Numeric Textbox, Numbers, Optional
Notes—It will store the customer notes in HTML format WYSIWYG Editor. Optional
Active—Boolean, Required, Filterable, Sortable

The Customer Management page is a Razor page (view) built inside of a shared view so that it can use the application's master header, menu, and footer. This page also has a corresponding method inside its controller. The method in the controller checks to see if the user is authenticated, has permissions, and sets a ViewBag with the user's ID. The method in the controller uses C #. The view uses HTML, C #, CSS, JavaScript, jQuery, and Angular to build out the panel bar, insert form, and grid. The panel bar is a Kendo Panel Bar built with an HtmlHelper block. It contains attributes for Name, Animation, and Items. The insert form is added to the “Items” section of the panel bar. The content inside the panel bar's “Item” section is using standard html tags with extra Angular properties on each of the input items that will be active in the scope of the Angular controller. Below the panel bar is the grid that uses a standard HTML div tag. The grid will be activated in the script section of the page. The script section of this page has several roles and executes asynchronously. When the page loads it will activate the Kendo UI Controllers, define data sources for the dropdowns, and create events that are stored inside the HTML DOM.

Activating Kendo UI Controllers activates input items such as textboxes, dropdowns, html editors, and grids. When the grid is activated, a data source is set to a method inside the controller that returns the list of customers as a JSON object. Properties for the grid are also defined. Examples of properties are width, pageable, scrollable, editable, etc.

This page is configured to respond to the following events:
“Add Customer” Button Click—When clicked it creates variables for each input item and assigns it the value of the Angular scope property on that input item. Then each input value is added to a JSON string using the JSON. Stringify method. Once the string is set as JSON then it posts that data to a method inside the CustomerController called “AddCustomer”. The AddCustomer method serializes the JSON string into a customer model object. Once it is an object, it is inserted into the database using Entity Framework. The results are passed back to the view and a message is displayed informing the user of the results.
Customer “Edit” Button Click—The “Edit” event will build out the form using a popup editor fired inside the script tag using a Kendo template. It will know what row the click fired from and load the data of that row into textboxes and other input items. Once the customer is edited it will post that data to the controller, and the controller will serialize the data into a customer model object and then update the row in the database using the Database Project.
Customer “Delete” Button Click—When clicked it will fire the destroy method inside the grid. That will post the object to the destroy method in the controller and mark that customer as deleted. It will not actually remove any records from the database.
“Locations” Button Click—The “Location” button event will display the location view corresponding to the customer ID.

Location Page, Role: Administrator. The Location page is where each Customer's Location(s) are tracked.

This page includes a “Panel Bar” that will open and collapse upon clicking. When opened it will display the Location Insert Form. When collapsed it will hide the Location Insert Form and has the title of “Add Location”. Under the “Panel Bar” is a grid listing all the Customer's Locations. It is a paging-enabled table with sortable column headers and data rows. Each row is a Location. In addition to the location data in each row there are also three buttons.
“Edit” button: When clicked it will disable the primary features of the location page with a shaded overlay and then opens a pop-up that lists all the location properties in an editable form.
“Delete” Button: When clicked it will prompt the Administrator user to verify that the location is to be deleted. If the action is verified, the location will be marked as deleted in the database. This does not remove the location from the database at this time but simply flags it as deleted rendering them effectively hidden. If “Cancel” is selected, the action is cancelled, and the normal screen will be displayed.
“Location Image Maps” Button: When clicked the location's image maps are displayed.

A sample location form may include the following fields:
Name—Textbox, Alpha-Numeric, Required, Filterable by Text, Sortable
Account Number—This will be manually assigned to fit the designated customer location identification scheme. Textbox, Alpha-Numeric, Required, Filterable by Text, Sortable
Address 1—Textbox, Alpha-Numeric, Required, Sortable
Address 2—Textbox, Alpha-Numeric, Optional, Sortable
City—Textbox, Alpha-Numeric, Required, Sortable
State—Dropdown containing all 50 States and Washington D.C., Alpha-Numeric, Required, Sortable
Zip Code—Textbox, Alpha-Numeric, Required, Sortable
Phone Number—Masked Textbox, Numeric, Required, Sortable
Location Logo—This will be uploaded to our server and used in reports. File Upload UI Component, Optional
Latitude—Numeric Textbox, Numbers, Optional
Longitude—Numeric Textbox, Numbers, Optional
Notes—It will store the location notes in HTML format using a WYSIWYG Editor. Optional.

The Location page is a Razor page (view) built inside of a shared view so that it can use the application's master header, menu, and footer. This page also has a corresponding method inside its controller. The method in the controller checks to see if the user is authenticated, has permissions, and sets two ViewBags with the User's ID and Customer's ID. The method in the controller uses C #. The view uses HTML, C #, CSS, JavaScript, jQuery, and Angular to build out the panel bar, insert form, and grid. The panel bar is a Kendo Panel Bar built with an HtmlHelper block. It contains attributes for Name, Animation, and Items. The insert form is added to the “Items” section of the panel bar. The content inside the panel bar's “Item” section is using standard html tags with extra Angular properties on each of the input items that will be active in the scope of the Angular controller. Below the panel bar is the grid that uses a standard HTML div tag. The grid will be activated in the script section of the page. The script section of this page has several roles and executes asynchronously. When the page loads it will activate the Kendo UI Controllers, define data sources for the dropdowns, and create events that are stored inside the HTML DOM.

Activating Kendo UI Controllers activates input items such as textboxes, dropdowns, html editors, and grids. When the grid is activated, a data source is set to a method inside the controller that returns the list of locations as a JSON object. Properties for the grid are also defined. Examples of properties are width, pageable, scrollable, editable, etc.

This page is configured to respond to the following events:
“Add Location” Button Click—When clicked it create variables for each input item and assigns it the value of the Angular scope property on that input item. Then each input value is added to a JSON string using the JSON. Stringify method. Once the string is set as JSON then it posts that data to a method inside the CustomerController called “AddLocation”. The AddLocation method serializes the JSON string into a location model object. Once it is an object, it is inserted into the database using the Database Project. The results are passed back to the view and a message is displayed informing the user of the results.
Location “Edit” Button Click—The “Edit” event will build out the form using a popup editor fired inside the script tag using a Kendo template. It will know what row the click fired from and load the data of that row into textboxes and other input items. Once the location is edited it will post that data to the controller and the controller will serialize the data into a location model object and then update the row in the database using the Data Project.
Location “Delete” Button Click—When clicked it will fire the destroy method inside the grid. That will post the object to the destroy method in the controller and mark that location as deleted. It will not actually remove any records from the database.
“Location Image Maps” Button Click—The “Location Image Maps” button event will display the LocationImageMap view corresponding to the location ID.

Location Image Map Page, Role: Administrator. The Location Image Map page is where the Customer's location is linked with the location image maps (effectively acting as 3D location models or images) of the physical building.

This page includes a “Panel Bar” that will open and collapse upon clicking. When opened it will display the LIM Insert Form. When collapsed it will hide the LIM Insert Form and has the title of “Add Location Image Map”. Under the “Panel Bar” is a grid listing all our customers in a table. It is a paging-enabled table with sortable column headers and data rows. Each row is an LIM with a unique ID provided by the camera manufacturer. In addition to the LIM data in each row there are also three buttons.
“Edit” button: When clicked it will disable the primary features of the LIM page with a shaded overlay and then opens a pop-up that lists all the LIM properties in an editable form.
“Delete” Button: When clicked it will prompt the Administrator user to verify that the LIM is to be deleted. If the action is verified, the LIM will be marked as deleted in the database. This does not remove the LIM from the database at this time but simply flags it as deleted rendering them effectively hidden. If “Cancel” is selected, the action is cancelled, and the normal screen will be displayed.
“Update Map” Button: When clicked the LIM's settings page is displayed. In the column to the right of the “Update Map” button is a “Map Updated” property showing whether the map is ready to view online. This property indicates to an Administrator whether or not the blueprint/mini-map corresponding to the LIM ID has been configured.

A sample LIM form may include the following fields:
Name—Textbox, Alpha-Numeric, Required, Sortable
Image API Token—When a location is shot with a camera system capable of tiling images together to form a 3D representation of a space, the captured images are uploaded to the manufacturer's service. Once processed, a token is generated to access the specifically uploaded images. Textbox, Alpha-Numeric, Required, Sortable
Grid Order—Textbox, Numeric, Required, Sortable
Thumbnail Icon—On the customer's LIM page for this location if there are multiple LIMs it will use the Thumbnail icons that is uploaded for each LIM to quickly switch between the different image sets. File Upload UI Component, Optional
Blueprint/Map—For each LIM there will be a corresponding blueprint/mini-map showing the user where they are in the main 3D version of the LIM. The camera manufacturer provides, through their API, a location spot for each time a camera captured images. Those spots will show up on the blueprint/mini-map, and the user will be able to click on the dots to transport from spot to spot without having to “walk-through” the LIM. There is also a dot for the user's current location inside the 3D LIM with a field-of-vision cone to show direction. File Upload UI Component, Optional

The LIM page is a Razor page (view) built inside of a shared view so that it can use the application's master header, menu, and footer. This page also has a corresponding method inside its controller. The method in the controller checks to see if the user is authenticated, has permissions, and sets a ViewBag with the Location's ID. The method in the controller uses C #. The view uses HTML, C #, CSS, JavaScript, jQuery, and Angular to build out the panel bar, insert form, and grid. The panel bar is a Kendo Panel Bar built with an HtmlHelper block. It contains attributes for Name, Animation, and Items. The insert form is added to the “Items” section of the panel bar. The content inside the panel bar's “Item” section is using standard html tags with extra Angular properties on each of the input items that will be active in the scope of the Angular controller. Below the panel bar is the grid that uses a standard HTML div tag. The grid will be activated in the script section of the page. The script section of this page has several roles and executes asynchronously. When the page loads it will activate the Kendo UI Controllers and create events that are stored inside the HTML DOM.

Activating Kendo UI Controllers activates input items such as textboxes, html editors, and grids. When the grid is activated, a data source is set to a method inside the controller that returns the list of LIMs as a JSON object. While creating the LIM object it checks to see if the Map has been set up properly. This check adds a green “Yes” or red “No” to the “Map Updated” property. Properties for the grid are also defined. Examples of properties are width, pageable, scrollable, editable, etc.

This page is configured to respond to the following events:
“Add LIM” Button Click—When clicked it will create variables for each input item and assigns it the value of the Angular scope property on that input item. Then each input value is added to a JSON string using the JSON. Stringify method. Once the string is set as JSON then it posts that data to a method inside the CustomerController called “AddLIM”. The AddCustomer method serializes the JSON string into a LocationImageMap model object. Once it is an object it is inserted into the database using the Database Project¹. The results are passed back to the view and a message is displayed informing the user of the results. ¹The Customer objects are added through the Entity Framework as described earlier on, and I just wanted to verify this differing manner of database entry.
LIM “Edit” Button Click—The “Edit” event will build out the form using a popup editor fired inside the script tag using a Kendo template. It will know what row the click fired from and load the data of that row into textboxes and other input items. Once the LIM is edited it will post that data to the controller and the controller will serialize the data into a customer object and then update the row in the database using the Data Project.
LIM “Delete” Button Click—When clicked it will fire the destroy method inside the grid.

That will post the object to the destroy method in the controller and mark that LIM as deleted. It will not actually remove any records from the database.
“Update Map” Button Click—The “Update Map” button event will display the location view with the LIM ID.

Map Settings Page, Role: Administrator. The Map settings page allows an administrator to align the camera location dots, provided by the camera manufacturer, with the uploaded blueprint/mini-map corresponding to the LIM.

This page uses the Location Image Map ID to get its specific API Token from the database. It then runs a script to add the API Token to the iFrame to load the 3D Image Map (comprising an image captured by a specialized camera) from the manufacturer Service. Inside of the Location Image Map (LIM), in the top-right corner, is the uploaded blueprint/mini-map displaying location dots corresponding to camera placement when capturing the image element of the LIM and a dot representing the position of the current user's simulated field-of-vision cone. To the left of the image frame are four numeric textboxes that allow the administrator to change the location of the top-left corner and the height/width of the element housing the camera location spots. Once the values are correctly configured and the mini-map lines up with the 3D Image map, the “Update Values” button should be clicked.

A sample Map Settings form may include the following fields:
Width: Numeric Textbox, required—This will manipulate the width of the element that is storing the camera location dots. This will save the number as pixels or percentage.
Height: Numeric Textbox, required—This will manipulate the height of the element that is storing the camera location dots. This will save as a percentage.
Left: Numeric Textbox, required—This will manipulate the left side starting point of the element that is storing the camera location dots. This will save a percentage.
Top: Numeric Textbox, required—This will manipulate the top of the element that is storing the camera location dots. This will save as a percentage.

The Map Settings page is a Razor page (view) built inside of a shared view so that it can use the application's master header, menu, and footer. This page also has a corresponding method inside its controller. The method in the controller checks to see if the user is authenticated, has permissions, and sets a few ViewBags with the LIM Information, Image Token, and File Path to the Blueprint/Mini-Map. The method in the controller uses C #. The view uses HTML, C #, CSS, JavaScript, jQuery, and Angular to create the map settings form, frame the LIM from the camera manufacturer's service, and build the mini-map that is integrated with the camera image spots. When the page loads it will activate the Kendo UI Controllers and populate the textboxes with either default values or it will make an ajax call to the server and request those values. When it retrieves the values from the application database, it will populate the textbox values and set the scope property for each. Next it makes a connection to the camera manufacture's API to retrieve the 3D Image Object. With that object we have the camera location dots, the current location of the user, and asset tags. With the location of the user and the dimensions of the 3D image field-of-view I can calculate the field-of-vision cone of the current user. The cone is built with a simple div and CSS. When the user looks around it changes the properties of the CSS to match with what the user is seeing in the 3D Image Map.

Activating Kendo UI Controllers activates textboxes and buttons.

This page is configured to respond to the following events:
Setting up 3D Image Map: The ViewBag object for the Matterpoint Token is passed in. A script configured to edit the source attribute on the iFrame that points to the right 3D Image Map is run when the page loads.
Setting up blueprint/mini-map: The ViewBag object for the image location for the blueprint/mini-map is passed in. The ViewBag object is used directly in the HTML using C # Razor.
Loading the camera location spots: A connection is created to the camera manufacturer's API, and the object using the Image Token is requested. The location of all the Camera Image Spots and the field-of-view dimensions of the current user's location are returned. The Camera Location Spot element is layered on top of the blueprint/mini-map. At first the dots will not line up and must be properly updated through the size and location textboxes.
Update the element location and size of the camera location spots: The four textboxes to the left of the 3D image map will allow movement and re-sizing of the camera location spots that were sent to the view by the camera manufacturer's API. The div that stores the element for the camera locations spots has a top, left, height, and width specified in-line with the element. When changing the value in the textboxes it calls a “Change” event in the JavaScript and that updates those CSS Attributes continuously to provide a view of work in progress.
“Update Values” Button Click—When clicked it creates variables and updates the scope of each textbox value. Then each value is added to a JSON string using the JSON.Stringify method. Once the string is set as JSON, it posts that data to a method inside the CustomerController called “UpdateMapValues”. The “UpdateMapValues” method serializes the JSON string into a customer model object. Once it is an object, it is inserted into the database using the Database Project. The results are passed back to the view and a message is displayed informing the user of the results.
Changing the Field-of-View cone for the current user that is in the blueprint/mini-map: Using the existing 3D Image object, the field-of-view that is displaying on the screen is determined. The field-of-view is stored as numeric dimensions. Those dimensions are used to determine the field-of-vision cone on the blueprint/mini-map. The cone is a div with CSS properties. Whenever the field-of-vision is moved, it calls an event that updates the dimensions calculation and changes the CSS to match.

Register User Page, Role: Administrator. This page will allow an administrator to set up a new user.

This page includes a standard HTML form and one button to submit the data to the server.
Submit Button: When clicked it will post the form data to the server and, once processed, will insert the new user in the database. There are two possible roles two choose from.
   Administrator: Has administrative permissions throughout the application.
   Location User: Only has access to the list of locations and corresponding Location Image Maps that they are assigned.
   Password Requirements: Minimum of 6 Characters. Requires at least one number or special character, at least one lowercase letter, and at least one uppercase letter.

A sample register user form may include the following fields:
First Name—Textbox, Alpha-Numeric, Required
Last Name—Textbox, Alpha-Numeric, Required
Role—Dropdown, Required
   DAS Admin
   Location User
Phone Number—Textbox, Alpha-Numeric, Optional
Email—Textbox, Alpha-Numeric, Required. This is also the username.
Password—Password Input Item, Alpha-Numeric, Required
Confirm Password—Password Input Item, Alpha-Numeric, required—Must match ‘Password’ field.

The Register User page is Razor page (view) built inside of a shared view so that it can use the application's master header, menu, and footer. This page also has a corresponding method inside its controller. The method in the controller checks to see if the user is authenticated and populates a ViewBag with a list of User Roles. This ViewBag will be used to populate the “Role” dropdown. The method in the controller uses C #. The view uses HTML, C #, CSS, JavaScript, jQuery, and Angular to build out the insert form. The registration form is wrapped in a Razor BeginForm “Using” block and is tied to the RegisterViewModel assigned to the view. All input items have HTMLHelpers defining what property of the ViewModel each input item belongs to. Once submitted it will create the object using the HTMLHelper names and submit that data to the view specified in the BeginForm “Using” block. When the data gets to the Registration POST method it will create the user object, execute the Create User method with its password specified. If it successfully adds the user, it will then assign the role to that user and return the admin back to the Register page displaying a result message.

Activating Kendo UI Controllers activates input items such as textboxes, dropdowns.

This page is configured to respond to the following events:
Insert Form Button Click—When clicked it will verify the password requirements, create the new user object using the data from the input items, and send that to the controller to be inserted.

The “Role” dropdown in the insert form is set in the AccountsContoller, with a ViewBag containing a list of Roles.

User Lists Page, Role: Administrator. This page has two list of users that are grouped by Role. A user is either an Administrator or a Location User.

This page has two grids listing users who have access to the application. If the user is in the “Admin” table then they have full permissions to the entire application and all available features. If the user is a “Location User”, then they only have access to locations that have been assigned to them. Each location will have a Location Image Map (or Maps) and allow that user to digitally traverse each location and view asset tags.

The only form on this page will open when an Administrator clicks the “Reset Password” button for a “Location User”. Each user will have their own “Reset Password” button tied to their UserId. This form will allow for the entry of a password and include a separate field to confirm the new password.

The User Lists page is a Razor page (view) built inside of a shared view so that it can use the application's master header, menu, and footer. This page also has a corresponding method inside its controller. The method in the controller checks to see if the user is authenticated and has permissions to view the page. The method in the controller uses C #. The view uses HTML, C #, JavaScript, and jQuery to build out the two grids. The grids are built, defined, and populated using Kendo HTMLHelpers for Razor. Each grid is tied directly to a ViewModel for each specific role. A DASAdminViewModel populates the top grid and the LocationUserViewModel populates the lower grid. The columns and data sources are defined inside the razor with no JavaScript needed. Each grid has its own separate data source. Inside the Location User grid is a password reset button for each user row. When clicked it will determine what row it was fired from and get the UserId of that user. It then calls a JavaScript event to activate the Kendo Popup and allow the user to type in a new password. Once the password is verified and confirmed then it will call a method in the controller to reset that user's password. The Kendo Popup Window closes upon submission.

Activating Kendo UI Controllers activates two grids. When the grids are activated, a data source is set to a method inside the controller that returns the list of users (either Administrator or Location User) as a JSON object. Properties for the grids are also defined. Examples of properties are width, pageable, scrollable, editable, etc.

This page is configured to respond to the following events:
“Reset Password” Button Click—The password for a Location User is reset by clicking this button. This calls a JavaScript event that grabs the row data where the button was clicked and creates a Kendo Popup Window that allows the administrator to reset the password.
“Reset” Button located in the Kendo Popup window after the new password has been typed and confirmed. This posts the data to a controller method called “ResetLocationUserPassword” along with the UserId.

Reset Password Page, Role: Administrator. This page allows the currently logged in user to reset their own password

The user will type in their current password in the top box, the new password in the middle box, and confirm the new password in the bottom box. There is a button called “Change Password” that will send the data to the controller and update the database. The new password must be a minimum of 6 Characters, at least one number or special character, at least one lowercase letter, and at least one uppercase letter.

A sample reset password form may include the following fields:
Current Password—Password Input Item, Alpha-Numeric, Required
New Password—Password Input Item, Alpha-Numeric, Required
Confirm Password—Password Input Item, Alpha-Numeric, required—Must match “New Password” field.

The Reset Password page is a Razor page (view) built inside of a shared view so that it can use the application's master header, menu, and footer. This page also has a corresponding method inside its controller. The method in the controller checks to see if the user is authenticated. The method in the controller uses C #. The view uses HTML, C #, and JavaScript. The Change Password form is wrapped in a Razor BeginForm “Using” block and is tied to the ChangePasswordViewModel that is assigned to the view. All input items have HTMLHelpers defining what property of the ViewModel each input item belongs to. Once submitted it will create the object using the HTMLHelper names and submit that data to the action specified in the BeginForm “Using” block. When the data gets to the ChangePassword ActionResult it will reset the user's password and redirect them back to the “Change Password” page displaying the Result Message.

This page is configured to respond to the following events:
“Change Password” Button Click—When clicked it will verify the password requirements, create the ChangePasswordViewModel object using the data from the input items, and send that to the controller to be updated.

Assign Users Page, Role: Administrator. This page will list out all active Location Users and allow an administrator to assign users to a specific location.

This page has a grid listing “Location Users”. For each user row in the grid, there is a button called “Assign Location”. When clicked it will redirect you to a page listing out all locations that can be assigned to that user. Each location will have a Location Image Map (or Maps) and allow that user to digitally traverse each location and view asset tags.

The grid may include the following columns:
“Assign Location” Button: This will display a page listing out all locations with checkboxes and allow the administrator to check which location the user has permission to view.
First Name: Sortable and filterable
Last Name: Sortable and filterable
Email: Sortable and filterable
Phone Number: Sortable and filterable

The Assign Users page is a Razor page (view) built inside of a shared view so that it can use the application's master header, menu, and footer. This page also has a corresponding method inside its controller. The method in the controller checks to see if the user is authenticated and has permissions to view the page. The method in the controller uses C #. The view uses HTML, C #, JavaScript, and jQuery to build out the User Location grids and define the event fired by clicking the button. The grid is built, defined, and populated using Kendo HTMLHelpers for Razor. The grid is tied directly to a LocationUserViewModel and sets its data source to an ActionResult in the customer controller. That ActionResult returns a list of ViewModel objects. Inside the “Location User” grid is an “Assign Location” button for each user row. When clicked it will determine what row it was fired from and get the UserId of that user. It then redirects that user to a new page where they can assign the locations.

This page is configured for a JavaScript event that is fired when the user clicks the “Assign Location” button. It grabs the current row in the grid and finds that User's ID. It then builds the URL and redirects that user to the new page.

Assign User Location Page, Role: Administrator. This page allows an administrator to assign specific locations to a Location User. When a Location User logs into the system they will only have access to the locations that have been assign to them from this page.

This page includes a grid that contains a list of locations. In each row of the grid is a checkbox that allows the administrator to select which facilities to assign to the Location User. When the locations are selected there is a button labeled “Assign User” that will post the data to the controller and update the database.

The grid may include the following columns:
Checkbox Column: This is an active checkbox that allows the administrator to select locations for assignment.
Account Number: Customer Account Number, Sortable, Filterable
Location Name: Sortable, Filterable
City: Sortable, Filterable
State: Sortable, Filterable

The Assign User Location page is a Razor page (view) built inside of a shared view so that it can use the application's master header, menu, and footer. This page also has a corresponding method inside its controller. The method in the controller checks to see if the user is authenticated, has permissions, and sets a ViewBag with the UserId of the user passed to this page from the previous page. The method in the controller uses C #. The view uses HTML, C #, CSS, JavaScript, and jQuery to build out the grid and define the “Assign User” button event. The grid that uses a standard HTML div tag and will be activated in the script section of the page. The script section of this page has several roles and executes asynchronously. When the page loads it will activate the Kendo UI Controllers, set up the Location grid, and create events that are stored inside the HTML DOM.

Activating Kendo UI Controllers activates the “Assign User” Button and Locations grid. When the grid is activated, a data source is set to a method inside the controller that returns the list of Location Users as a JSON object. Properties for the grid are also defined. Examples of properties are width, pageable, scrollable, editable, etc.

This page is configured to respond to the following events:
“Assign User” Button Click—When the button is clicked, it loops through the grid rows and checks to see if that row is selected. If it is selected, it pushes the UserId and LocationId to an array that is to be converted to JSON and submitted to the controller. The controller will serialize the JSON object to a list of LocationUserLocation objects and then add them to the database using the Database Project. The administrator is then shown the result message on this page.

Location User Portal Page, Role: Location User. When a user with the role of “Location User’ logs into the platform they are directed to the “Location User Portal”.

This page features a dropdown that will allow the user to switch between the locations that they have been assigned. Within the Location Image Map (LIM) they can digitally traverse their site, watch their progress on the mini-map, and click to view assets that have been tagged within the LIM. Depending on the size of the location, the location can be divided into multiple LIMs, each having a specific image captured from different camera positions, that are aggregated or gridded together to fully depict the location. To the right of the current LIM image are the thumbnails to the other LIM images corresponding to the selected location. The user can click the thumbnails and load the corresponding LIM.

A sample location image map form may include the following properties:
Locations: Dropdown, required—Fires the event that will switch the user's location and updates the screen elements.

The Location Image Map page is a Razor page (view) built inside of a shared view so that it can use the application's master header, menu, and footer. This page also has a corresponding method inside its controller. The method in the controller checks to see if the user is authenticated and has permissions. The method in the controller uses C #. The view uses HTML, C #, CSS, JavaScript, jQuery, and Angular to populate the Locations dropdown, frame the LIM from the camera manufacturer's service, and build the mini-map that is integrated with the camera image spots. When the page loads it will activate the Kendo UI Controllers and populate the dropdown with a list of locations that the logged in user has permission to view. Next it makes a connection to the camera manufacture's API to retrieve the 3D Image Object corresponding to an LIM. With that object we have, in addition to the viewable image(s) of the location's area captured by the camera that comprise an effective 3D-modelled space, the camera location dots, the current location of the user, and asset tags. With the location of the user and the dimensions of the 3D image “field-of-view”, the field-of-vision cone of the current user on the mini-map can be calculated. The cone is built with a simple div and CSS. When the user looks around, it recalculates the field-of-vision and changes the properties of the CSS to match with what the user is seeing in the 3D Image Map. To the right of the LIM image being displayed, if needed, images of additional LIMs corresponding to the current location may be displayed via a thumbnail grid. The thumbnails have been uploaded through the Admin Portal.

Activating Kendo UI Controllers activates the location dropdown.

This page is configured to respond to the following events:
Setting the data source of the Location dropdown by activating it as a Kendo UI script and specifying the URL to a controller that returns a list of locations. It checks the UserID stored in a session variable to get the correct list.
Creating the Thumbnail grid of multiple LIMs. On page load, an ajax call is made to the controller to get the list of LIMs for the selected location. For each LIM, a thumbnail with several data properties is set up. These data properties are used to configure the blueprint/mini-map.
Setting up 3D Image Map: The Image token is stored as a data attribute of the currently selected thumbnail. On page load, a script configured to edit the source attribute on the iFrame and point it to the correct 3D Image Map is run.
Setting up the blueprint/mini-map: Using the currently selected thumbnail, the data attribute for the mini-map image location is retrieved. Then, using jQuery, the image source to the value of the data property in the thumbnail is set.
Loading the camera location spots: a connection to the camera manufacturer's API is created and the object is requested using the Image Token. The location of all the Camera Image Spots and the field-of-view dimensions of the current user's location is returned. I am layering the Camera Location Spot element on top of the blueprint/mini-map.
Changing the Field-of-View cone for the current user that is in the blueprint/mini-map: Using the existing 3D Image object, the field-of-view that is displaying on the screen is determined. The field-of-view is stored as numeric dimensions. Those dimensions are used to calculate the field-of-view cone on the blueprint/mini-map. The cone is a div with CSS properties. Whenever the field-of-vision is moved, an event is called that updates the calculation and changes the CSS to match.

Relationships between the mapped location data, platform, and external devices are described below in terms of views or pages which provide additional platform functionality that will assist in potential emergency situations at any location stored in the platform's database.

GPS Tracking Integration. A view is created that will allow an Administrator to set GPS coordinates around the perimeter of a mini-map that has been previously uploaded. Once the GPS coordinates are set, the application will calculate the latitude and longitude of the facility's or location's interior. jQuery “onClick” events are used to create the GPS coordinate and mark the pixel location on the image that the coordinate was set on. If the image is sized down on the 3D Image Settings page, then the application will re-calculate the GPS point. The calculation will be based on percentage. If the image is shrunk by 12% then the new GPS point will also be shrunk by 12%. The pixel is a whole number so if the re-calculated value is a decimal then round up or down using standard math rules.

Assign Devices to Personnel Users. A view is created to manage Personnel Users. These users will not have access to the system but will be assigned GPS devices. This view will capture information such as name, employee ID, Title, etc. and save them to the database. Once the Personnel User is created, they can be linked them to a GPS Device. The GPS device will have a QR code stamped on the back of the device that will allow a Location User to select a Personnel User from a list and scan the device when prompted. The Location User will also be able to make a Personnel User and GPS device in-active. If a Personnel User is made inactive, it will remove the device from that user and make it available in inventory. There will also be a view to scan in devices that are not assigned to a user. This will help the customer keep track of how many devices are assigned vs. unassigned in inventory.

GPS Information on location's map. A Windows Service that utilizes thread pools is built. Creating multiple threads will allow the server to communicate with many GPS Devices at once. A GPS Device manufacturer will have an API or SDK that can be used to make these requests. Each request will return the GPS Device's latitude and longitude. Then it will update that device's location in the application database along with a time stamp of that reading. The server will be constantly communicating with the API—even if nobody is logged into the application. On the client side there will be an ajax call to the application database requesting a list of GPS devices for the specific location the user is accessing. It will then loop through these devices and put a dot on the map for the calculated latitude and longitude pixel location. This call will run continuously while the user is on that view. The Location User can toggle the GPS dots “On” and “Off”.

GPS Personnel Tracking View. A view is created for the Location Image “floor plan mode”. The floor plan mode will be a top-down view of the facility. This will feature a larger version of the mini-map and will allow the user to click and span around in the image if the facility's floor plan is too large to fit on the screen. Scripts will be run on this page and configured put the GPS dots on this screen and the Location User can mouse-over the dots to see who that person is and view the date and time of the last reading.

What is claimed is:

1. A system for interfacing with a 3D-modelled space comprising:
a digital three-dimensional (3D) representation of a location;
data representing a geographic position of said location; and
a digital location interface platform, wherein said digital location interface platform is configured to allow a user to access said digital 3D representation of said location.

2. The system of claim 1 wherein said location is an interior of a structure.

3. The system of claim 2 wherein said digital location interface platform is further configured to receive data representing a geographic position of a positioning device.

4. The system of claim 3 wherein said digital location interface platform is further configured to cause said geographic position of said positioning device to be indicated to said user through said digital 3D representation of said location when said positioning device is located within said location.

5. The system of claim 4 wherein said digital 3D representation of said location comprises at least one digital image of said location.

6. The system of claim 5 further comprising object data representing a property of an object located within location, and wherein said digital location interface platform is further configured to allow a user to access said object data through interaction with said digital 3D representation of said location.

7. A method for interfacing with a 3D-modelled space comprising:
generating a digital three-dimensional (3D) representation of a location;
obtaining data representing a geographic position of said location; and
running on a computing device a digital location interface platform configured to allow a user to access said digital 3D representation of said location.

8. The method of claim 7 wherein said location is an interior of a structure.

9. The method of claim 8 further comprising obtaining data representing a geographic position of a positioning device.

10. The method of claim 9 further comprising causing said geographic position of said positioning device to be indicated to said user through said digital location interface platform when said geographic position of said positioning device is located within said location.

11. The method of claim 10 wherein said digital 3D representation of said location comprises at least one digital image of said location.

12. The method of claim 11 further comprising causing object data representing a property of an object located within said location to be indicated to said user via interaction with said digital 3D representation of said location through said digital location interface platform.
